(19) United States
(12) Patent Application Publication
(10) Pub. No.: US 2017/0155428 A1
(43) Pub. Date: Jun. 1, 2017

(54) CONVEYOR TRUCK WITH PORTABLE RADIO OPERATING UNIT

(71) Applicant: Jungheinrich Aktiengesellschaft, Hamburg (DE)

(72) Inventors: Ralf Wetegrove, Norderstedt (DE); Florian Grabbe, Hamburg (DE)

(21) Appl. No.: 15/358,421

(22) Filed: Nov. 22, 2016

(30) Foreign Application Priority Data
Nov. 27, 2015 (DE) 102015120686.2

(51) Int. Cl. H04B 5/00; H04L 29/12; H04W 12/06; H04W 4/00; H04W 76/02

(52) U.S. Cl. CPC H04B 5/0031; H04W 4/008; H04B 5/0056; H04W 76/02; H04W 12/06; H04L 61/6022

(57) ABSTRACT

An industrial truck with a vehicle radio module fixed to the vehicle and a portable radio control unit, which, in a coupled state, can wirelessly transmit operating commands to the vehicle radio module in a first protocol, wherein the vehicle radio module and the radio command unit each have an additional radio unit for an initial pairing, each of which exchanges an identification address for the first protocol.

### CROSS REFERENCE TO RELATED INVENTION

This application is based upon and claims priority to, under relevant sections of 35 U.S.C. §119, German Patent Application No. 102015120686.2, filed Nov. 27, 2015, the entire contents of which are hereby incorporated by reference.

### BACKGROUND OF THE INVENTION

The present invention relates to an industrial truck with a vehicle radio module fixed to the vehicle and a portable radio control unit. The invention also relates to a method for operating an industrial truck remotely using a portable radio control unit.

A portable, wireless radio remote control system for a material handling device is known from WO 2008/039649. The radio remote control system is worn by the operator like a glove or another piece of clothing and thus transported by the user without needing to be held or carried. The radio remote control system consists of a transmitter and an operating apparatus coupled with the transmitter via a cable, on which the user can transmit driving commands. In order to establish a connection, the driver can set a pairing mode on the industrial truck. For this, a list of the identification codes of all transmitters located in range is displayed on the industrial truck. The user checks the listed identification codes of the transmitters and selects the one that corresponds with the currently carried remote control system. The remote control system is coupled with the industrial truck by confirming the identification code. A disadvantage of the known method is that the selecting or entering of an identification code on the industrial truck is error-prone and time-consuming.

It is known from the document NFCForum-AD-BTSSP_1.0 with the title “Bluetooth Secure Simple Pairing Using NFC” to use NFC units in a Bluetooth network, wherein NFC stands for near-field communication. These units are used in order to establish a device connection or a secure connection or to trigger the start of usage.

WO 2015/007056 suggests using an NFC unit to authenticate the devices for a Bluetooth connection.

The object of the invention is to establish, in an industrial truck with a radio remote control, a radio connection between the vehicle radio module and the radio remote control in a simple manner that is not too time-consuming.

### BRIEF SUMMARY OF THE INVENTION

The industrial truck according to the invention has a vehicle radio module fixed to the vehicle and a portable radio control unit. In a coupled state between the vehicle radio module and the radio control unit, operating commands and other signals can be wirelessly transmitted to the vehicle radio module in a first protocol. The industrial truck can be remotely controlled via the operating commands provided for this. According to the invention, the vehicle radio module and the radio control unit are respectively equipped with an additional radio unit, which executes an initial pairing. Within the framework of the pairing, identification addresses for the vehicle radio module and for the radio control unit are exchanged in order to be able to establish a data connection via the first protocol. In the case of the industrial truck according to the invention, in addition to the units, which effectuate a data exchange via the first protocol, additional radio units are provided, which establish the pairing between the vehicle with its vehicle radio module and the portable radio control unit.

In an embodiment, the radio control unit has a readable and rewritable NFC unit. In the NFC unit, a unique identification address of the radio control unit can be stored and read from the memory. Moreover, the received identification address of the vehicle radio module can be saved in the NFC unit.

In another embodiment, the vehicle radio module is equipped with an NFC module, which has a transceiver. The NFC module can be designed differently than the NFC unit, for example, in order to establish an NFC connection on its own. The NFC unit is supplied with power when the NFC module approaches the vehicle radio module and then transmits its MAC address to the NFC module.

In an embodiment, the operating commands are exchanged via Bluetooth between the vehicle radio module and the radio control unit. In the Bluetooth protocol, the MAC address of the vehicle radio module and the radio control unit preferably stand for the exchanged identification addresses. The MAC address can also be used by the Bluetooth protocol for a unique connection and assignment.

An advantage of the industrial truck according to the invention as compared to conventional industrial trucks is clear when a plurality of radio control units are present. Each of the radio control units is designed to perform the initial pairing with the vehicle radio module fixed to the vehicle via its radio unit. The advantage of the industrial truck according to the invention is that quick pairing is possible when using a plurality of radio control units. In contrast, in the case of a conventional pairing, in which the user is offered a list of identification numbers, when there are a plurality of radio control units and their identification numbers, their representation quickly becomes confusing for the user. Mix-ups within the list can also be avoided.

In an embodiment, the additional radio units are formed by the radio control unit and the vehicle radio module in order to perform the initial pairing in a near field. The pairing preferably takes place without an additional user-side input.

A completed pairing is preferably signaled to the user by a confirmation apparatus attached to the vehicle. This can occur optically and/or acoustically on the vehicle. In general, the confirmation apparatus on the vehicle could also additionally or exclusively trigger a confirmation process on the radio control unit.

The object according to the invention is also solved by a method for operating an industrial truck remotely. The method uses a portable radio control unit, which transmits operating commands to a vehicle radio module fixed to the vehicle in a first protocol, wherein the vehicle radio module and radio control unit each have an additional radio unit. The method according to the invention provides for an initial pairing step where the additional radio unit of the radio control unit transmits its identification address for the first protocol to the radio unit of the vehicle radio module. The radio unit of the vehicle radio module transmits its identification address for the first protocol to the radio unit of the radio control unit. A connection between the radio unit of the vehicle radio module and the radio control unit is established via the first protocol using the identification addresses. A special aspect of the method according to the invention is that a pairing takes place without active intervention by the user.

The process of the initial pairing is preferably started in that the radio control unit is held up to the vehicle radio module at a distance of less than 20 cm, preferably less than 10 cm. The advantage thereby achieved becomes particularly clear when a plurality of radio control units are available from which the user can freely select. The user selects a radio control unit that has not yet been connected and holds it spatially near the vehicle radio module. The pairing is hereby performed without further action if the vehicle radio module is not yet connected.

Once the pairing has taken place, a Bluetooth connection can be established for the data exchange. The pairing takes place via near-field communication.

### BRIEF DESCRIPTION OF THE DRAWINGS

A preferred exemplary embodiment is explained in more detail below using the figures. The figures show the following:

FIG. 1 illustrates an industrial truck according to the invention in a view from the side with a schematically represented radio control unit; and

FIG. 2 illustrates a temporal flow chart for the establishment of the Bluetooth connection.

### DETAILED DESCRIPTION OF THE INVENTION

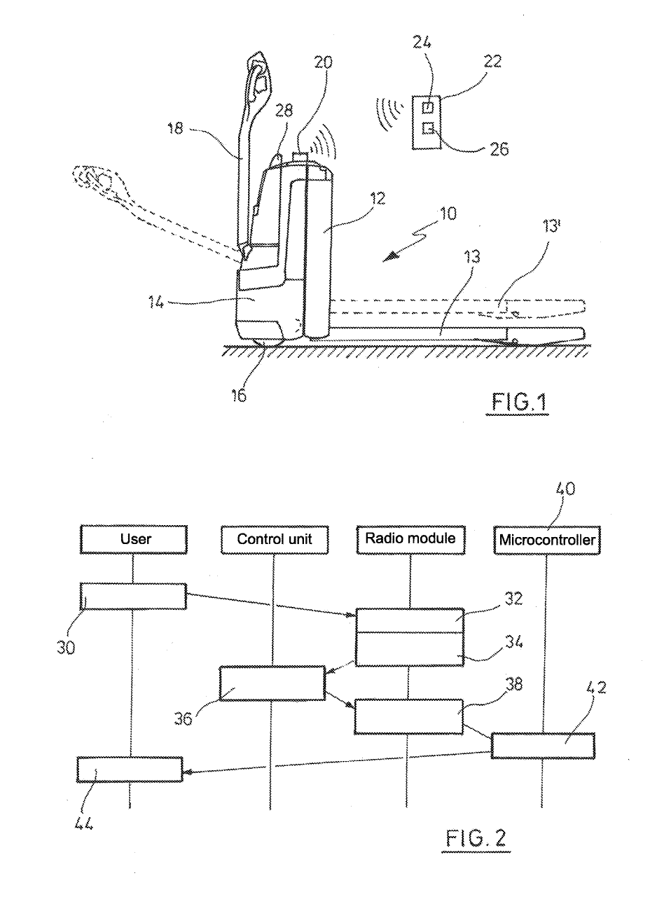

FIG. 1 shows, in a view from the side, a low-lift truck 10, which has a load part 12 and a drive part 14. The load part 12 has two load arms 13, which can be lifted into a raised position 13′. The drive part 14 has a steering and driving wheel 16, the alignment of which is preselectable by the drawbar 18.

The vehicle shown in FIG. 1 has a vehicle radio module 20 attached to the drive part 14 of the vehicle, which is in radio connection with a radio control unit 22. The radio control unit 22 is schematically equipped with two control elements 24 and 26 in FIG. 1. If a control element 24, 26 is actuated on the radio control unit 22, the corresponding confirmation signal is transmitted by the radio control unit 22 and received by the vehicle radio module 20. The received confirmation signal is forwarded to a vehicle controller 40. Furthermore, an optical display unit 28 can be seen in FIG. 1, which displays, in an easily visible manner by a light or flashing signal, that a radio connection was established between the vehicle radio module 20 and the portable radio control unit 22. The vehicle radio module 20 preferably has an NFC module, which can read data from nearby NFC units and can also write data to the NFC units. The radio control unit 22 is equipped with a readable and rewritable NFC unit.

FIG. 2 shows the establishment of the Bluetooth connection in a temporal flow chart. In a first step 30, a user holds the radio control unit 22 near the vehicle radio module 20. The distance is hereby preferably less than 20 cm, particularly preferably less than 10 cm. It can also be provided that the radio control unit 22 is brought in direct contact with the vehicle radio module 20 in order to establish a pairing. In a subsequent step 32, the vehicle radio module 20 detects that a radio control unit is located nearby. In the following process step 34, the vehicle radio module transmits its identification number to the control unit 22. It receives the identification address in process step 36 and transmits its identification address back to the radio module, which receives it in process step 38. The exchange of data between process steps 34 and 36 as well as process steps 36 and 38 takes place via near-field communication. With the help of near-field communication, the MAC addresses for the subsequent Bluetooth connection are exchanged.

If the two MAC addresses are available, the vehicle radio module 20 forwards the paired MAC addresses to a vehicle controller 40. In process step 42, the vehicle controller 40 tasks the vehicle radio module 20 with establishing a radio connection to the user via the MAC addresses in step 44.

### REFERENCE NUMBER LIST

10 Low-lift truck
12 Load part
13 Load arms
13′ Position of the load arms
14 Drive part
16 Driven wheel
18 Drawbar
20 Vehicle radio module
22 Radio control unit
24 Control element
26 Control element
28 Display unit
30 Process step
32 Process step
34 Process step
36 Process step
38 Process step
40 Vehicle controller
42 Process step
44 Process step

1-13. (canceled)

14. An industrial truck comprising:
a vehicle radio module; and
a portable radio control unit configured to pair with the vehicle radio module and wirelessly transmit operating commands to the vehicle radio module in a first protocol,
wherein the vehicle radio module and the portable radio control unit each have an additional radio control unit configured to perform an initial pairing, and wherein the vehicle radio module and the portable radio control unit each exchange an identification address for the first protocol.

15. The industrial truck according to claim 14, wherein the portable radio control unit has a readable and rewritable NFC unit.

16. The industrial truck according to claim 14, wherein the vehicle radio module has an NFC module with a transceiver.

17. The industrial truck according to claim 14, wherein the exchanged identification addresses represent MAC addresses of the vehicle radio module and the portable radio control unit.

18. The industrial truck according to claim 14, wherein the operating commands are exchanged using Bluetooth.

19. The industrial truck according to claim 14, wherein a plurality of additional radio control units is provided, and wherein each of the plurality of additional radio control units is configured to perform the initial pairing with the vehicle radio module via its respective additional radio unit.

20. The industrial truck according to claim 19, wherein the plurality of additional radio units are formed by the portable radio control unit and vehicle radio module and configured to perform the initial pairing in a near field.

21. The industrial truck according to claim 14, wherein the initial pairing takes place without input from a user.

22. The industrial truck according to claim 14, further including a confirmation apparatus configured to indicate a completed pairing.

23. A method for initial pairing of a portable radio control unit with a vehicle radio module, the method comprising:
transmitting an identification address for a first protocol from an additional radio unit of a radio control unit to a radio unit of the vehicle radio module;
transmitting the identification address for the first protocol from the radio unit of the vehicle radio module to the radio unit of the radio control unit; and
establishing a connection between the radio unit of the vehicle radio module and the radio unit of the radio control unit using the first protocol.

24. The method according to claim 23, wherein initial paring occurs when the radio control unit is held up to the vehicle radio module at a distance of less than 20 cm.

25. The method according to claim 23, wherein a Bluetooth connection is established between the portable radio control unit and the vehicle radio module.

26. The method according to claim 24, wherein the initial pairing takes place via near-field communication.
